(19) United States
(12) Patent Application Publication
(10) Pub. No.: US 2024/0305650 A1
(43) Pub. Date: Sep. 12, 2024

(54) INTERPRETABLE SYSTEM WITH INTERACTION CATEGORIZATION

(71) Applicant: Visa International Service Association, San Francisco, CA (US)

(72) Inventors: Xiao Tian, Austin, TX (US); Chiranjeet Chetia, Round Rock, TX (US); Jianhua Huang, Cedar Park, TX (US)

(73) Assignee: Visa International Service Association, San Francisco, CA (US)

(21) Appl. No.: 18/549,519

(22) PCT Filed: Mar. 17, 2022
(86) PCT No.: PCT/US2022/020717

§ 371 Date: Sep. 7, 2023

Related U.S. Application Data
(60) Provisional application No. 63/162,330, filed on Mar. 17, 2021.

(51) Int. Cl. H04L 9/40; G06N 3/0455

(52) U.S. Cl. CPC H04L 63/1416; G06N 3/0455

(57) ABSTRACT

A method is disclosed. The method comprises receiving, by a server computer comprising an auto-encoder module, a first dataset containing first feature values corresponding to features of an interaction. The first dataset may be input into the auto-encoder module. The auto-encoder module may output a second dataset, the second dataset containing a second feature values corresponding to features of the interaction. The server computer may then compute a feature deviation dataset using the first dataset and the second dataset. The method can then comprise determining a type of activity based on the feature deviation dataset.

### CROSS-REFERENCES TO RELATED APPLICATIONS

This application is a PCT application, which claims priority to and the benefit of U.S. Provisional Patent Application No. 63/162,330, filed on Mar. 17, 2021, which is herein incorporated by reference.

### BACKGROUND

Existing algorithms can classify data based on known data, but the classification of the data may be quite general, and finer categorization of classified data is often desirable. For example, malicious interactions occur in many different scenarios, and there is a need to identify interactions that are not currently labeled as being malicious or not malicious. Such interactions can be generally classified by a computer as being malicious, but further information is needed to determine reason why particular interactions are malicious. For example, interactions can be labeled malicious or fraudulent because an account was part of a pyramid scheme or because an account was obtained by a hacker. There is a need to understand the reasons why interactions are malicious, so that the operators or managers of such interaction systems know how to address them. While it may be possible to manually analyze data to determine the reasons why interactions are malicious, this is slow and cumbersome. It may also not be practical to do so if there is a large amount of interaction data.

Embodiments of the disclosure address this problem and other problems individually and collectively.

### SUMMARY

One embodiment of the invention includes a method. The method comprises: receiving, by a server computer comprising an auto-encoder module, a first dataset comprising a first plurality of feature values, the first plurality of feature values corresponding to a plurality of features of an interaction; inputting the first dataset into the auto-encoder module; outputting, by the auto-encoder module, a second dataset, the second dataset comprising a second plurality of feature values corresponding to the plurality of features of the interaction; computing, by the server computer, a feature deviation dataset using the first dataset and the second dataset; and determining, by the server computer, a type of activity based on the feature deviation dataset.

Another embodiment includes a server computer comprising a processor and a non-transitory computer readable medium. The non-transitory computer readable medium comprising instructions executable by the processor to perform operations including: receiving, by a server computer comprising an auto-encoder module, a first dataset comprising a first plurality of feature values, the first plurality of feature values corresponding to a plurality of features of an interaction; inputting the first dataset into the auto-encoder module; outputting, by the auto-encoder module, a second dataset, the second dataset comprising a second plurality of feature values corresponding to the plurality of features of the interaction; computing, by the server computer, a feature deviation dataset using the first dataset and the second dataset; and determining, by the server computer, a type of activity based on the feature deviation dataset.

A better understanding of the nature and advantages of embodiments of the invention may be gained with reference to the following detailed description and accompanying drawings.

### BRIEF DESCRIPTION OF THE DRAWINGS

FIG. 1 shows a block diagram of a fraud scoring system.

FIG. 2 shows a block diagram of an interpretable categorization system according to embodiments.

FIG. 3 shows a block diagram of categorization workflow according to embodiments.

FIG. 4 shows a block diagram of an auto-encoder according to embodiments.

FIG. 5 shows an illustration of computing a feature deviation dataset according to embodiments.

FIG. 6 shows an illustration of determining a sorted feature deviation dataset according to embodiments.

FIG. 7A shows a first sorted feature deviation dataset according to embodiments.

FIG. 7B shows an account takeover feature network according to embodiments.

FIG. 8A shows a second sorted feature deviation dataset according to embodiments.

FIG. 8B shows an authorized push interaction feature network according to embodiments.

FIG. 9A shows a third sorted feature deviation dataset according to embodiments.

FIG. 9B shows a pyramid scam feature network according to embodiments.

FIG. 10 shows a regular sorted feature deviation dataset according to embodiments.

FIG. 11 shows an unresolved sorted feature deviation dataset according to embodiments.

FIG. 12 shows a block diagram of an exemplary server computer according to embodiments.

### DETAILED DESCRIPTION

Prior to discussing embodiments of the disclosure, some terms can be described in further detail.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “user” may include an individual. In some embodiments, a user may be associated with one or more personal accounts and/or mobile devices. The user may also be referred to as a cardholder, account holder, or consumer in some embodiments.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “feature” may be an individual measurable property or characteristic of a phenomenon being observed. An “interaction feature” may include a measurable property or characteristic of an interaction. Examples of interaction features may include times and/or data of interactions, the parties involved in interactions, the amounts of interactions, terms of interactions, the goods, services, or rights being transacted in interactions, interaction velocity, network activity, outflow amount, account numbers, IP addresses, etc.

A “feature value” may be a value associated with a particular feature. For example, an interactions feature such as “amount” may have a feature value such as $10.00.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

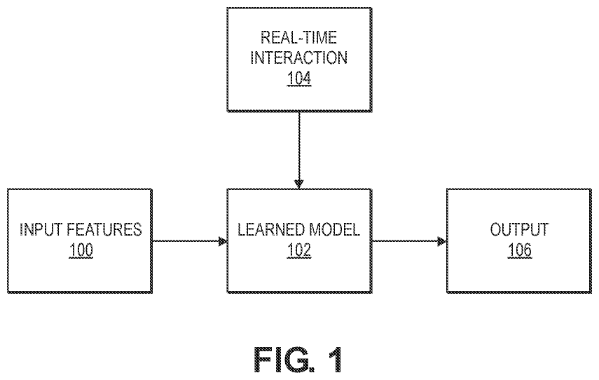

FIG. 1 shows a block diagram of a fraud scoring system. The fraud scoring system could be used to determine if a transaction is a fraudulent transaction by assigning a fraud score to the transaction. A set of input features 100 can be used to train a learned model 102. The set of input features 100 may be a set of transaction features of a transaction. Examples of transaction features can include an amount, a location of the transaction, an IP address associated with the transaction, parties to the transaction, account numbers used in the transaction, transaction velocities associated with parties to the transaction, etc.

The learned model 102 may be a machine learning model (e.g., an unsupervised learning model) that is trained using a plurality transactions. The learned model 102 may learn the underlying patterns behind legitimate transactions.

In embodiments, a real-time interaction 104 may be fed into the learned model 102 and a fraud score can be associated to it. For example, the real-time interaction 104 can be a transaction may be fed to the learned model 102, which compares it to the learned patterns of legitimate transactions. The learned model 102 may assign a fraud score to the real-time interaction 104 based on how different the patterns of the real-time interaction 104 are to the underlying patterns of legitimate transactions.

A fraud score may be an output 106 of the fraud scoring system. In many traditional implementations, the fraud score is a number, and if the fraud score is above some threshold, the real-time interaction 104 is flagged for further investigation. Further investigation can include an operator of the fraud scoring system reviewing the real-time interaction 104 to determine more information regarding the fraudulent real-time interaction 104.

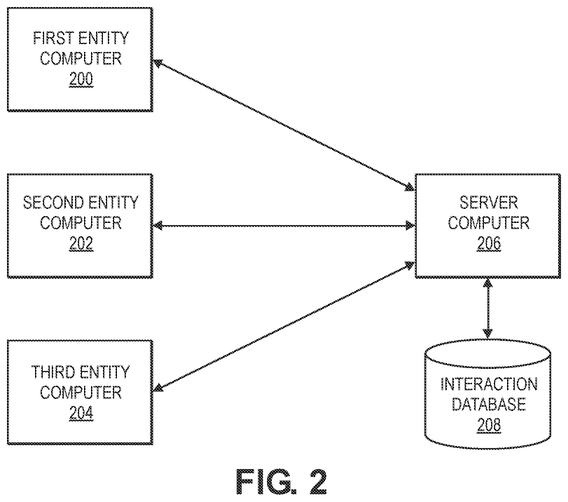

FIG. 2 shows a block diagram of an interpretable categorization system according to embodiments. The interpretable categorization system can comprise a first entity computer 200 operated by a first entity, a second entity computer 202 operated by a second entity, a third entity computer 204 operated by a third entity, a server computer 206 operated by a processing network, and an interaction database 208 coupled to the server computer 206. The first entity, second entity, and third entity may be similar entities. For example, in a fraud categorization system, the first entity may be a first bank, the second entity may be a second bank, and the third entity may be a third bank. The server computer 206 may receive interaction data from the first entity computer 200, the second entity computer 202, and/or the third entity computer 202. The interaction data can comprise data for a plurality of interactions, where interaction data for one specific interaction is in a first dataset comprising a first plurality of feature values corresponding to a plurality of features for an interaction. The interaction data may be stored by the server computer 206 in the interaction database 208 coupled to the server computer 206. In a fraud categorization system, the three entities may provide transaction data to the server computer 206, which can be stored in the interaction database 208. Other example interpretable categorization systems can include network analysis systems, such as those used to analyze web page traffic, where the interaction data is network data (e.g., an IP address of a web page requestor, an access timestamp, a number of web page requests, etc.).

The components in the universal interaction system of FIG. 2 and any of the following figures can be in operative communication with each other through any suitable communications medium. Suitable examples of the communications medium may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices of FIG. 1 may be transmitted using a secure communications protocol such as, but not limited to, File Transfer Protocol (FTP); HyperText Transfer Protocol (HTTP); and Secure Hypertext Transfer Protocol (HTTPS).

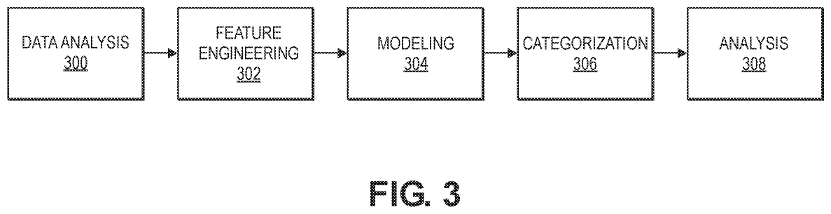

FIG. 3 shows a block diagram of categorization workflow according to embodiments. The categorization workflow may be used to determine a type of activity of an interaction. The categorization workflow may include a data analysis 300 block, a feature engineering 302 block, a modeling 304 block, a categorization 306 block, and an analysis 308 block. The categorization workflow may be 15 implemented in the interpretable categorization system of FIG. 2. For example, the server computer 206 may be configured to perform the functions of the above blocks.

The data analysis 300 block may include analyzing interactions in the interaction database 208 received by the server computer 206 from the plurality of entity computers (e.g., the first entity computer 200, the second entity computer 202, and the third entity computer 204). Initial analysis of the features can be performed to provide analysis on the univariate distribution of features, multivariate interdependencies of features, etc.

The feature engineering 302 block may include a selection of a number of features of an interaction to be used by the modeling 304 block. Features of an interaction may be categorized into several types including interaction level features, account features, long-term features, velocity features, and graph features. Interaction level features may include interaction features unique to the specific interaction, such as a timestamp, a receiver and/or sender account number, an interaction amount, etc. Account features may include interaction features related to an account used to perform the interaction, such as an account type (e.g., for a transaction, the account type may be a “business” or “personal” account indicator). Long-term features may include interaction features related to the amount of interactions performed by a user over a long period of time, such as the number of interactions performed by the user in the last one month, the number of interactions performed by the user in the last three months, etc. Velocity features may include interaction features related to the amount of interactions performed by a user over a short period of time, such as the number of interactions performed by the user in the last five minutes, the number of interactions performed by the user in the last hour, etc. Graph features may include interaction features related to the interaction network of a user, such as the accounts or web pages that the user commonly interactions with. The feature engineering 302 block may additionally include determining a predetermined set of features associated with a type of activity. Additionally, each type of activity may be associated with a feature network. For example, short-term features such as velocity features may be associated with an unauthorized user accessing an account performing the interaction (e.g., an account takeover). The associated feature network may show one malicious user performing malicious interactions with one or more affected users.

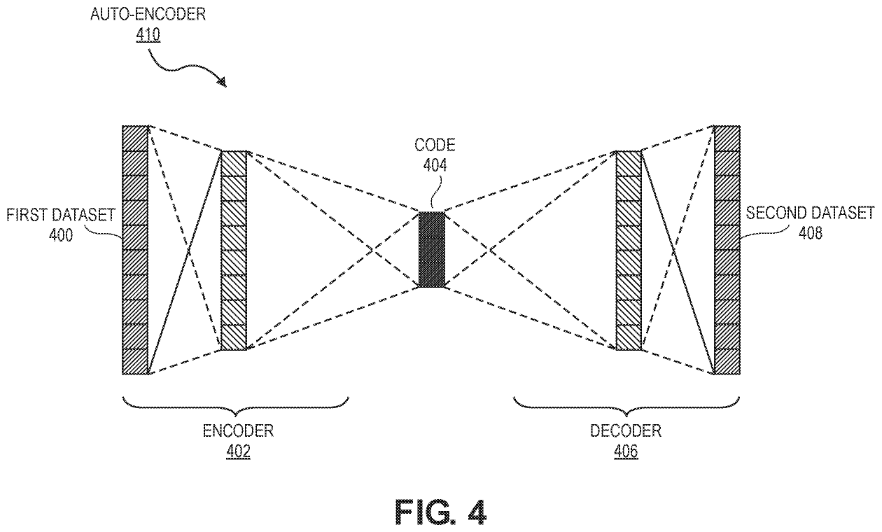

The modeling 304 block may include determining a model used to analyze interactions. For example, the modeling 304 block may include training a machine learning model to analyze a set of input interactions. The modeling 304 block may train a machine learning model to learn the underlying patterns of interactions. For example, for a fraud detection system, the modeling 304 block may include training a machine learning model to learn the underlying patterns of legitimate transactions using a set of known legitimate transactions. Examples of the machine learning model can include an auto-encoder module that takes an input interaction, learns the hidden representation of the input interaction, and attempts to reconstruct the interaction, which is further described in FIG. 4. After the machine learning model is trained, the modeling 304 block may include applying the machine learning model to a set of interactions received from a plurality of entities. The modeling 304 block may analyze each interaction individually. For example, a server computer may input a first dataset comprising a first plurality of feature values corresponding to a plurality of features for an interaction received from an entity computer into an auto-encoder module to analyze the interaction of the first dataset.

The categorization 306 block may include determining a type of activity based on the output of the modeling 304 block. For example, a first dataset comprising a first plurality of feature values, the first plurality of feature values corresponding to a plurality of features for an interaction may be input into an auto-encoder module of a server computer. The resultant output of the auto-encoder module may be a second dataset comprising a second plurality of feature values corresponding to the plurality of features for the interaction. The categorization 306 block may include computing a feature deviation dataset using the first dataset and the second dataset. In some embodiments, the feature deviation dataset may be sorted before determining a type of activity. A type of activity may then be determined based on the feature deviation dataset, or the sorted feature deviation dataset. For a fraud detection system, the categorization 306 block may determine a type of fraud occurring (e.g., account takeover fraud, pyramid scam fraud, email compromise fraud, authorized push transaction fraud, etc.), if any. For a network analysis system, the categorization 306 may determine a type of network request being made (e.g., a legitimate web request, a distributed denial-of-service (DDoS) attack, etc.) and may indicate a preferred action to take based on the type of network request (e.g., allow or block the request).

The analysis 308 block may include further analysis of the output of the categorization 306 block. For example, the analysis 308 block may include generating a list of interactions and their assigned category for an operator to look at. In a fraud detection system, the analysis 308 block may include aggregating fraudulent transactions based on their fraud type, and outputting the list of all fraudulent transactions. The analysis 308 block may also include transmitting an indication of the interaction of the first dataset. For example, the server computer 206 may transmit an indication of the interaction of the first dataset it received to the first entity computer 200. The server computer 206 and/or the first entity computer 200 may then further process the malicious interaction, such as sending a confirmation to the user that performed the interaction.

FIG. 4 shows a block diagram of an auto-encoder 410 according to embodiments. The server computer 206 may include the auto-encoder in an auto-encoder module. The auto-encoder 410 may be used as a machine learning model in the modeling 304 block of FIG. 3. After the server computer 206 receives, from an entity computer (e.g., any one of the first entity computer 200, the second entity computer 202, the third entity computer 204), a first dataset comprising a first plurality of feature values, the first plurality of feature values corresponding to a plurality of features for an interaction, the first dataset may be input into the auto-encoder. For example, in a fraud categorization system, the server computer 206 may receive the first dataset 400 from the first entity computer 200, and the first dataset 400 may comprise interaction data of an interaction performed in associated with the first entity computer 200. The server computer 206 may input the transaction data into the auto-encoder 410. The auto-encoder 410 may comprise an encoder 402 and a decoder 406. The encoder 402 can be used to learn a code 404 (e.g., a hidden representation) of the first dataset 400. The decoder 406 may reconstruct the first dataset 400 using the code 404, and output a second dataset 408. The second dataset 408 may be a reconstruction of the first dataset 400 and may comprise a second plurality of feature values corresponding to the plurality of features for the interaction.

The encoder 402 and the decoder 406 may comprise a number of convolutional neural network layers or recurrent neural network layers. The encoder 402 can comprise any number of layers, used to reduce the dimensionality of a received first dataset 400. For illustrative purposes, the encoder 402 may comprise only a single layer. The single layer may map a vector F with elements fᵢ to a hidden representation Z using the equation: Z=σ(WF+b)=σ(Σwᵢfᵢ+b), where σ is an activation function (e.g., a sigmoid function such that σ(WF+b)=1/[1+e^{-(WF+b)}]), W is a weighting matrix with elements wᵢ, and b is a bias vector. The decoder 406 may then reconstruct the first dataset 400 using the hidden representation Z as F′=σ′(W′Z+b′). Examples of auto-encoders are described in detail in Umberto Michelucci, “An Introduction to Autoencoders,” arXiv preprint, arXiv:2201.03898v1, January 2022, which is incorporated by reference.

The set of (σ, W, b) may be a first set of learnable parameters relating to the encoder 402 and the set of (σ′, W′, b′) may be a second set of learnable parameters relating to the decoder 406 and are unrelated to (σ, W, b). The first set of learnable parameters and the second set of learnable parameters may be tuned via the minimization of a loss function such as mean squared error function, a mean absolute loss function, a cross-entropy loss function, etc. One such loss function follows: [symbol] (F,F′)=∥F−F′∥²=∥F−σ′(W′(σ(WF+b))+b′)∥². The loss function may be used as a quality parameter for the reconstruction of the first dataset 400 by the second dataset 408. For example, the first set of learnable parameters and the second set of learnable parameters can be learned by feeding the auto-encoder 410 a set of known legitimate, or “regular” interactions (e.g., legitimate transactions, legitimate web requests) and modifying the first set of learnable parameters and the second set of learnable parameters to minimize the loss function. The first set of learnable parameters and the second set of learnable parameters learned can be used by the auto-encoder 410 to reconstruct regular interactions with low deviations. However, underlying patterns behind malicious interactions are different than regular interactions, and as such the first set of learnable parameters and the second set of learnable parameters would lead to a reconstructed interaction with large deviations from the input interaction. For example, for a fraud categorization system, both sets of learnable parameters may be learned by feeding known legitimate transactions to the auto-encoder 410. The first set of learnable parameters and the second set of learnable parameters may be learned using the legitimate transactions. When the auto-encoder 410 thereafter receives a legitimate transaction as a first dataset 400 with first feature values, the auto-encoder 410 can output a second dataset 408 with second feature values that has low deviation (e.g., most of all of the second feature values are reconstructed to be similar to the first feature values). However, upon receiving a fraudulent transaction as a first dataset 400 with first feature values, the auto-encoder 410 may output a second dataset 408 with second feature values that has high deviation (e.g., one or more of the second feature values are reconstructed with values significantly different than the first feature values).

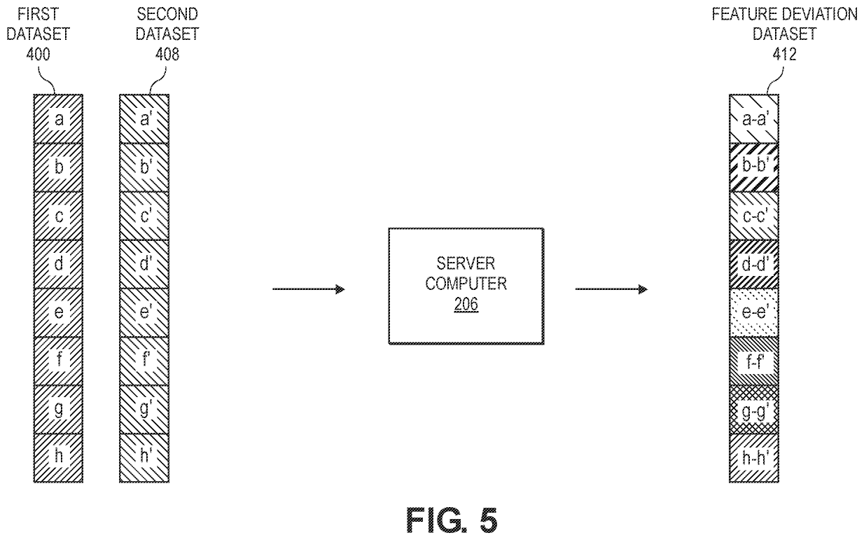

FIG. 5 shows an illustration of computing a feature deviation dataset 412 according to embodiments. After the auto-encoder 410 outputs the second dataset 408, the server computer 206 may compute a feature deviation dataset using the first dataset 400 and the second dataset 408. The feature deviation dataset 412 may be computed using a first dataset 400 that was input into the auto-encoder 410, and the resultant second dataset 408. The first dataset 400 may comprise a first plurality of feature values corresponding to a plurality of features for an interaction, shown as F=(σ, b, c, d, e, f, g, h) in FIG. 4. The second dataset 408 may comprise a second plurality of feature values corresponding to the plurality of features for the interaction, shown as F′=(σ′, b′, c′, d′, e′, f′, g′, h′) in FIG. 4. The server computer 206 may compute the feature deviation dataset 412 by computing the absolute difference between the first dataset 400 and the second dataset 408. The feature deviation dataset 412 may thus be equal to |F−F′|=(|a−a′|, |b−b′|, |c−c′|, |d−d′|, |e−e′|, |f−f′, ∥g−g′|, |h−h′|).

For example, the first dataset 400 may correspond to transaction features of a legitimate transaction, and may be in the form of a vector F=(1, 2, 4, 8), where 1 may be a feature value for a feature representing the type of account, 2 may be a feature value for a representing an account, 4 may be a feature value for a feature representing a transaction amount, and 8 may be a feature value for a feature representing a transaction time (e.g., the vector F=(1, 2, 4, 8) represents a transaction of $4 performed by account 2 account of type 1 at 8:00 am). In real applications, the first dataset 400 can comprise hundreds of features and corresponding feature values for an interaction. The encoder 402 of the auto-encoder 410 may learn a code 404 of the first dataset 400. The decoder 406 may then reconstruct the first dataset 400 as the second dataset 408 using the code 404. For example, the second dataset 408 may be generated in the form of a vector F′=(0, 1, 5, 4). Thus, the feature deviation dataset 412 may be |F−F′|=(1,1,3,4), where the fourth feature has the largest deviation but is still relatively small. In another example, the first dataset 400 may correspond to transaction features of a fraudulent transaction, and may be in the form of a vector B=(1, 2, 10000, 8). Because the auto-encoder 410 was trained using legitimate transactions, the first set of learnable parameters and the second set of learnable parameters correspond to legitimate transactions. The auto-encoder 410 may reconstruct the first dataset 400 as the second dataset 408 using the code 404. For example, the second dataset 408 may be generated in the form of a vector B′=(1, 2, 10, 4). In this second example, the feature deviation dataset 412 may be |F−F′|=(0,0,9990,4), indicating the third feature value has a very large deviation.

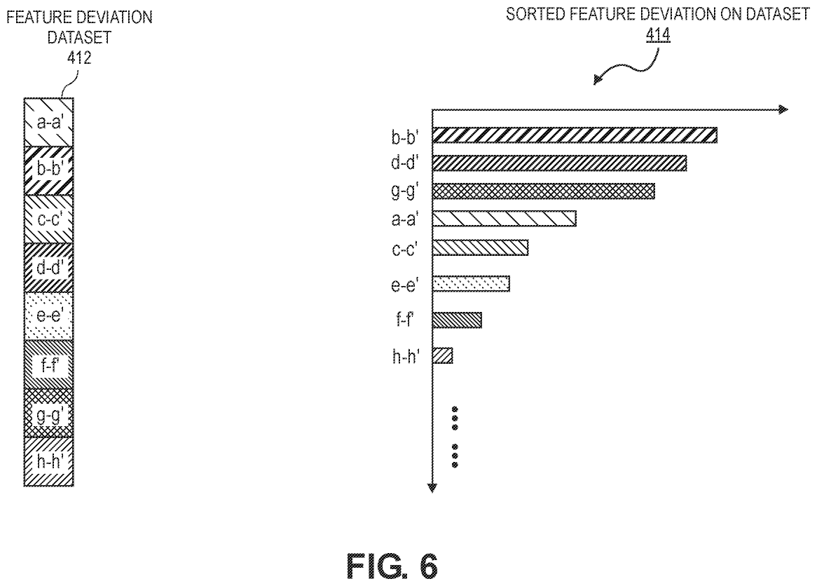

FIG. 6 shows an illustration of determining a first sorted feature deviation dataset 414 according to embodiments. After the server computer 206 computes a feature deviation dataset 412 using the first dataset 400 and the second dataset 408, the feature deviation dataset 412 may be sorted according to the magnitude of the feature deviation to determine a sorted feature deviation dataset 414. The sorted feature deviation dataset 414 may be used to determine which feature value of the interaction has the largest deviation. As the auto-encoder 410 is trained using legitimate, regular interactions, the auto-encoder 410 is proficient at reconstructing input first datasets which correspond to legitimate interactions. However, upon receiving a first dataset corresponding to a malicious or fraudulent interaction, the auto-encoder 410 produces a second dataset which has large deviations from the first dataset. The server computer 206 may then use the sorted feature deviation dataset 414 to quickly identify which features have the largest deviations. The server computer 206 can then determine type of activity based on the feature deviation dataset 412 and/or the sorted feature deviation dataset 414. After determining the type of activity, the server computer 206 may transmit an indication of the interaction to the entity computer from which the first dataset was received. For example, if the server computer 206 received the first dataset from the first entity computer 200, the server computer 206 may notify the first entity computer 200 that the interaction may be a malicious interaction of a certain type (e.g., a fraudulent account takeover transaction).

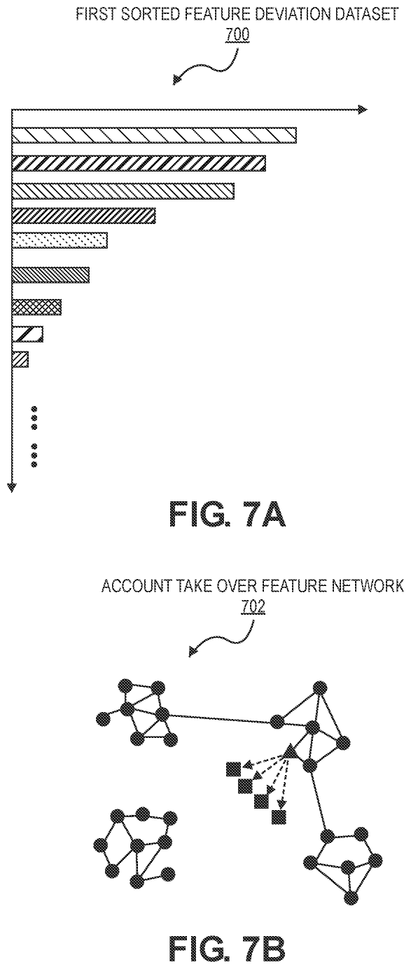

For example, for a fraud categorization system, several of the features of the interaction may indicate a type of fraud occurring. Several examples follow in FIGS. 7-11. In the following examples, nodes may indicate accounts (e.g., a bank account, an IP address of a web page), where a circle is a normal account, a triangle is an affected account, and a square is a malicious account. Lines may indicate interactions (e.g., a transaction between two accounts, a computer accessing a web page hosted by a web hosting computer, etc.), where a solid line is a legitimate interaction, and a dashed line is a malicious interaction.

FIG. 7A shows a first sorted feature deviation dataset 700 according to embodiments. The first sorted feature deviation dataset 700 may have a large deviation in the velocity features of the interaction. For example, the first sorted feature deviation dataset 700 may indicate that there is a large deviation in one or more sender velocity features relating to the amount of transactions performed by a user in the past two hours, past five minutes, and/or past minute. Other features, such as long-term features, may have lower deviations.

FIG. 7B shows an account takeover feature network 702 according to embodiments. The first sorted feature deviation dataset 700 may indicate the largest deviations occur in sender velocity features, indicating a large change in the short-term behavior of the user. Additionally, sender velocity features are “sender side” features, meaning that they originate from a sender of a transaction. At the feature engineering block 302 of FIG. 3, the server computer 206 may be configured to determine account takeover fraud (e.g., a malicious user has accessed the user's account to perform unauthorized transactions) is indicated by a large deviation in sender velocity features. Thus, the server computer 206 may determine, based on the first sorted deviation dataset 700 (or the unsorted deviation dataset), that the type of activity is an account takeover fraud.

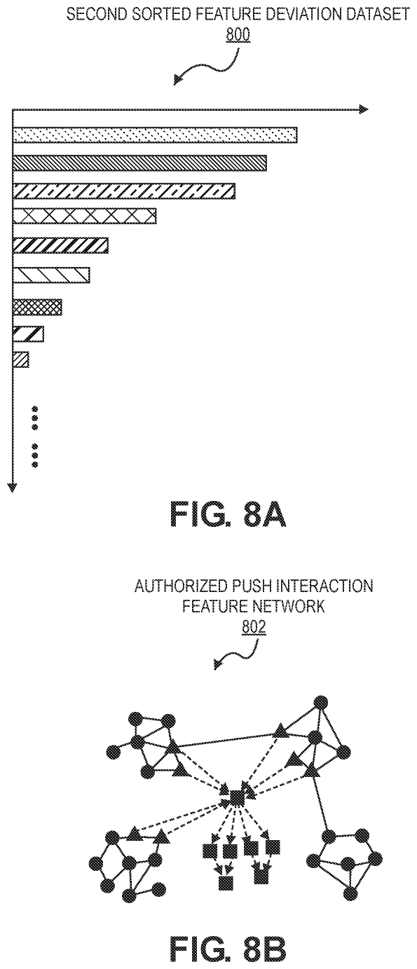

FIG. 8A shows a second sorted feature deviation dataset 800 according to embodiments. The second sorted feature deviation dataset 800 may indicate the largest deviations occur in one or more receiver velocity features of the interaction, indicating a large change in the short-term behavior of the user. For example, the second sorted feature deviation dataset 800 may indicate that there is a large deviation in a receiver velocity feature relating to the amount of transactions received by a user in the past day, past two days, and the past week. Other features, such as long-term features, may have lower deviations.

FIG. 8B shows an authorized push interaction feature network 802 according to embodiments. The second sorted feature deviation dataset 800 may indicate the largest deviations occur in the receiver velocity features, indicating a large change in the short-term behavior of the user. Additionally, receiver velocity features are “receiver side” features, meaning that they originate from the receiver of a transaction. At the feature engineering block 302 of FIG. 3, the server computer 206 may be configured to determine authorized push payment fraud (e.g., a malicious user is manipulating other users to make payments to the malicious user) is indicated by a large deviation in receiver velocity features. Thus, the server computer 206 may determine, based on the second sorted deviation dataset 800 (or the unsorted deviation dataset), that the type of activity is authorized push payment fraud.

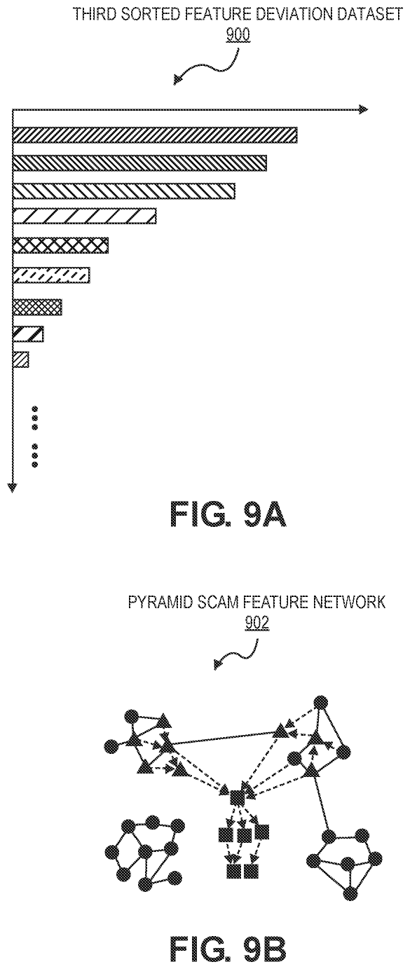

FIG. 9A shows a third sorted feature deviation dataset 900 according to embodiments. The third sorted feature deviation dataset 900 may indicate the largest deviations occur in one or more graph features of the interaction. For example, the third sorted feature deviation dataset 900 may indicate there is a large deviation in the network activity, and the outflow amount of the user. Other features, such as velocity features, may have lower deviations.

FIG. 9B shows a pyramid scam feature network 902 according to embodiments. The third sorted feature deviation dataset 900 may indicate the largest deviations occur in the graph features. Graph features, such as network activity and outflow amount, may indicate a flow of transactions being routed to a set of malicious users. At the feature engineering block 302 of FIG. 3, the server computer 206 may be configured to determine a pyramid scam fraud (e.g., an set of malicious users are manipulating other users to make payments to the set of malicious users through several transaction hops). Thus, the server computer 206 may determine, based on the third sorted deviation dataset 900 (or the unsorted deviation dataset), the type of activity is pyramid scam fraud.

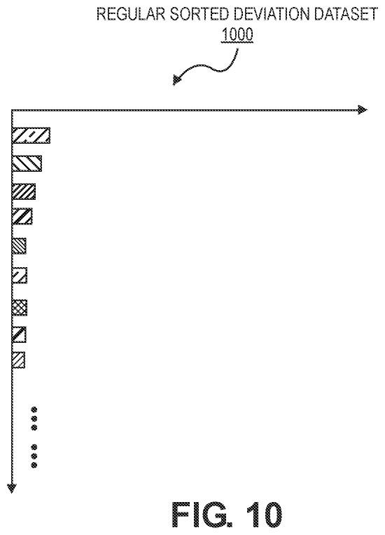

FIG. 10 shows a regular sorted feature deviation dataset 1000 according to embodiments. The regular sorted feature deviation dataset 1000 may indicate there are no large deviations in any features of the interaction. Remembering that the auto-encoder 410 is trained using legitimate transaction data, the auto-encoder 410 is able to accurately reconstructed legitimate transactions used as input. Because all of the deviations are small in the regular sorted feature deviation dataset 1000, the server computer 206 may determine the type of activity is regular activity.

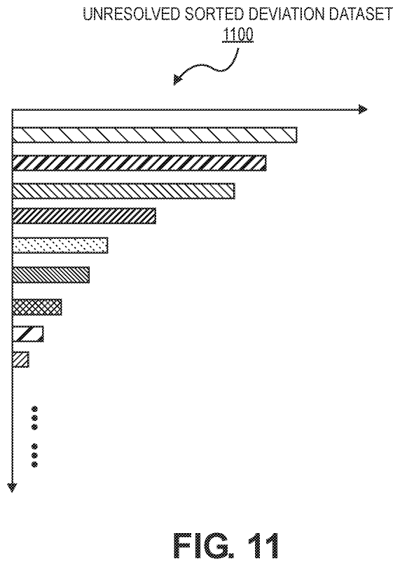

FIG. 11 shows an unresolved sorted feature deviation dataset 1100 according to embodiments. The unresolved sorted feature deviation dataset 1100 may indicate there are large deviations in several features of the interaction. Unlike the sorted feature deviation datasets of FIGS. 7-9, there is no clear set of features that have large deviations, rather, all of the features have a significant deviation. The unresolved sorted feature deviation dataset 1100 may indicate an error to the server computer 206. Example errors that can cause such the unresolved sorted feature deviation dataset 1100 can include system errors, such as errors in feature aggregation (e.g., feature values were assigned to the wrong features), or a shift in transaction behaviors has occurred (e.g., the auto-encoder 410 is trained using old data).

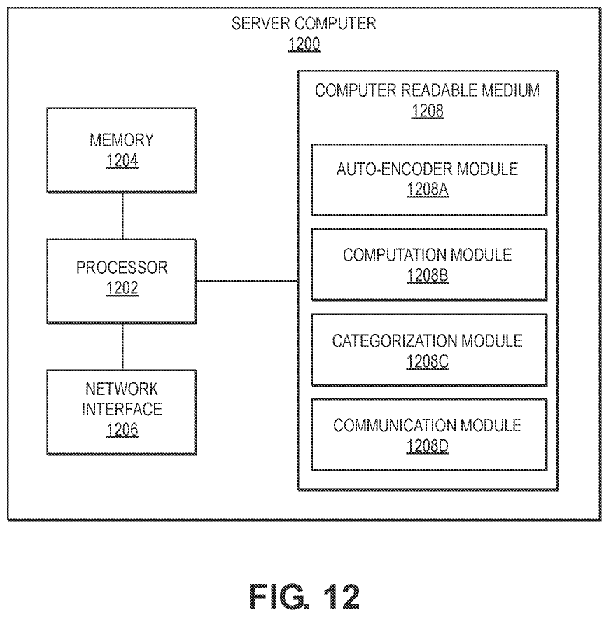

FIG. 12 shows a block diagram of an exemplary server computer 1200 according to embodiments. The server computer 1200 may comprise a processor 1202, which may be coupled to a memory 1204, a network interface 1206, and a computer readable medium 1208.

The memory 1204 may contain data of smart contracts and interaction channels, etc. The memory 1204 may be coupled to the processor 1202 internally or externally (e.g., via cloud-based data storage), and may comprise any combination of volatile and/or non-volatile memory such as RAM, DRAM, ROM, flash, or any other suitable memory device. The memory 1204 may include, or be coupled to a separate interaction database that stores interaction data received from a plurality of entity computers.

The network interface 1206 may include an interface that can allow the server computer 1200 to communicate with external computers and/or devices. The network interface 1206 may enable the server computer 1200 to communicate data to and from another device such as an entity computer. Some examples of the network interface 1206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 1206 may include Wi-Fi. Data transferred via the network interface 1206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 1206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 1208 may comprise code, executable by the processor 1202, for a method comprising: receiving, by a server computer comprising an auto-encoder module, a first dataset comprising a first plurality of feature values, the first plurality of feature values corresponding to a plurality of features of an interaction; inputting the first dataset into the auto-encoder module; outputting, by the auto-encoder module, a second dataset, the second dataset comprising a second plurality of feature values corresponding to the plurality of features of the interaction; computing, by the server computer, a feature deviation dataset using the first dataset and the second dataset; and determining, by the server computer, a type of activity based on the feature deviation dataset.

The computer readable medium 1508 may comprise a number of software modules including, but not limited to, an auto-encoder module 1208A, a computation module 1208B, a categorization module 1208C, and a communication module 1208D.

The auto-encoder module 1208A may comprise code that causes the processor 1202 perform the actions of an auto-encoder. For example, the auto-encoder module 1208A may include an encoder and a decoder comprising a plurality of neural network layers. The auto-encoder module 1208A may take as input a first dataset and reconstruct the first dataset by outputting a second dataset.

The computation module 1208B may comprise code that causes the processor 1202 to perform computations. For example, the computation module 1208B may allow the processor 1202 to compute a loss of a loss function, compute a feature deviation dataset, sort a feature deviation dataset, etc.

The categorization module 1208C may comprise code that causes the processor 1202 assign a type of activity to an interaction. For example, the categorization module 1208C may be configured to determine a type of activity based on a feature deviation dataset or a sorted feature deviation dataset. The categorization module 1208C may store a mapping between a predetermined set of features and a type of activity. For example, the categorization module 1208C may store a mapping between “sender velocity features” and “account takeover.”

The communication module 1208D may comprise code that causes the processor 1202 to generate messages, forward messages, reformat messages, and/or otherwise communicate with other entities.

Embodiments provide for several advantages. Embodiments allow a processing network operating a server computer to detect and categorize interactions such as malicious interactions. In contrast to many traditional detection systems, embodiments provide for a method to both detect potential malicious interactions and determine a type of activity occurring in the malicious interaction without further need of manual analysis. Large datasets can be easily and quickly processed and analyzed using embodiments of the invention. Further, the data being analyzed does not have to have labels to determine patterns in the data, and no special models are needed for interpretation of the data.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a server computer comprising an auto-encoder module, a first dataset comprising a first plurality of feature values, the first plurality of feature values corresponding to a plurality of features of an interaction;
inputting the first dataset into the auto-encoder module;
outputting, by the auto-encoder module, a second dataset, the second dataset comprising a second plurality of feature values corresponding to the plurality of features of the interaction;
computing, by the server computer, a feature deviation dataset using the first dataset and the second dataset; and
determining, by the server computer, a type of activity based on the feature deviation dataset.

2. The method of claim 1, wherein determining the type of activity based on the feature deviation dataset comprises sorting the feature deviation dataset.

3. The method of claim 1, wherein the first dataset is received from an entity computer and wherein the interaction corresponds to an interaction performed in association with the entity computer.

4. The method of claim 1, wherein the plurality of features of the interaction comprise one or more of interaction level features, account features, long term features, velocity features, or graph features.

5. The method of claim 1, wherein the auto-encoder module comprises an encoder comprising a plurality of neural network layers and a decoder comprising a plurality of neural network layers.

6. The method of claim 1, wherein the type of activity is one of account take over fraud, email compromise fraud, authorized push interaction fraud, or pyramid scam fraud.

7. The method of claim 1, further comprising:
transmitting, by the server computer to an entity computer, an indication of the interaction of the first dataset.

8. The method of claim 1, further comprising:
determining, by the server computer, a loss of a loss function using the first dataset and the second dataset.

9. The method of claim 8, further comprising:
modifying, by the server computer, a first set of learnable parameters and a second set of learnable parameters to minimize the loss of the loss function.

10. The method of claim 1, after inputting the first dataset into the auto-encoder module, the method further comprising:
determining, by the auto-encoder module, a hidden representation of the first dataset; and
generating, by the auto-encoder module, the second dataset by reconstructing the first dataset using the hidden representation of the first dataset.

11. The method of claim 1, wherein the type of activity is associated with a feature network.

12. The method of claim 1, wherein the feature deviation dataset is determined by computing an absolute difference between the first dataset and the second dataset.

13. The method of claim 1, wherein the type of activity is associated with large deviations in a predetermined set of features.

14. The method of claim 1, wherein the auto-encoder module is trained using known legitimate interactions.

15. A server computer comprising:
a processor; and
a non-transitory computer readable medium comprising instructions executable by the processor to perform operations including:
receiving, an auto-encoder module of the server computer, a first dataset comprising a first plurality of feature values, the first plurality of feature values corresponding to a plurality of features of an interaction;
inputting the first dataset into the auto-encoder module;
outputting, by the auto-encoder module, a second dataset, the second dataset comprising a second plurality of feature values corresponding to the plurality of features of the interaction;
computing, by the server computer, a feature deviation dataset using the first dataset and the second dataset; and
determining, by the server computer, a type of activity based on the feature deviation dataset.

16. The server computer of claim 15, wherein determining the type of activity based on the feature deviation dataset comprises sorting the feature deviation dataset.

17. The server computer of claim 15, wherein a first set of learnable parameters correspond to an encoder of the auto-encoder module and a second set of learnable parameters correspond to a decoder of the auto-encoder module.

18. The server computer of claim 15, wherein the second dataset is determined using a sigmoid function.

19. The server computer of claim 15, wherein the plurality of features of the interaction comprise one or more of interaction level features, account features, long term features, velocity features, or graph features.

20. The server computer of claim 15, wherein the auto-encoder module is associated with a loss function, and wherein the loss function is a mean squared error loss function.
